(19) United States
(12) Patent Application Publication
(10) Pub. No.: US 2024/0393628 A1
(43) Pub. Date: Nov. 28, 2024

(54) LIQUID CRYSTAL ENABLED RECONFIGURABLE PHOTONIC INTEGRATED CIRCUIT

(71) Applicant: University of Massachusetts, Boston, MA (US)

(72) Inventors: Amir Arbabi, Boston, MA (US); Andrew McClung, Boston, MA (US); Babak Mirzapourbeinekalaye, Boston, MA (US); Ayyoub Dehmollaian, Boston, MA (US)

(21) Appl. No.: 18/669,249

(22) Filed: May 20, 2024

Related U.S. Application Data
(60) Provisional application No. 63/503,224, filed on May 19, 2023.

(51) Int. Cl. G02F 1/13; G02F 1/015; G02F 1/025

(52) U.S. Cl. CPC G02F 1/1326; G02F 1/0154; G02F 1/025; G02F 1/216; G02F 1/217; G02F 1/225; G02F 1/3132; G02F 2201/06; G02F 2202/103; G02F 2203/62

(57) ABSTRACT

An exemplary reconfigurable optical vector-matrix multiplier (VMM) and related optical waveguide switch are provided herein that can be employed in linear, reconfigurable photonic integrated circuits using CMOS electronic drivers developed and optimized for liquid crystal displays (LCDs). The approach can be straightforward to manufacture as compared to counterpart PIC and lower in cost. Devices based on the disclosed VMM can be programmed and reprogrammed in real-time to realize different PICs for applications in, e.g., optical communications, linear optical classical and quantum computing, neuromorphic computing, and optical sensing.

### RELATED APPLICATION

This U.S. patent application claims priority to, and the benefit of, U.S. Provisional Patent Application No. 63/503,224, filed May 19, 2023, entitled “Liquid Crystal Enabled Reconfigurable Photonic Integrated Circuit,” which is incorporated by reference here in its entirety.

### BACKGROUND

Photonic integrated circuits (PICs) generally include predefined on-chip optical waveguides, e.g., fabricated using integration platforms such as indium phosphide (InP), silicon-oninsulator (SOI), silica, and lithium niobate, and have been deployed in optical communication networks.

Existing PICs are generally fabricated using lithography and etching or diffusion processes; thus, their functionality is fixed, and they are sensitive to inevitable fabrication imperfections and variations. To shorten the design cycle and lower the cost of application-specific PICs, partially reconfigurable PICs based on arrays of waveguides and tunable components (e.g., Mach-Zehnder interferometers) have been proposed and demonstrated. However, such multipurpose PICs often have sensitivity to fabrication errors and consume significant electrical power. Several approaches for reconfiguring PICs have been pursued by academia and industry, including thermal and electrooptic phase shifters, electroabsorptive switches, and microelectromechanical systems (MEMs), but they have been hindered by their high-power consumption, large device footprints, and limited reconfigurability. There are benefits to improving the designs of photonic integrated circuits.

### SUMMARY

An exemplary reconfigurable optical vector-matrix multiplier (VMM) and related optical waveguide switch are provided herein that can be employed in linear, reconfigurable photonic integrated circuits using CMOS electronic drivers developed and optimized for liquid crystal displays (LCDs). The exemplary VMM device can be straightforward to manufacture as compared to counterpart PIC and lower in cost. The exemplary VMM can be configured as a reconfigurable processing unit or waveguide that can be programmed and reprogrammed in real-time to realize different PICs for applications in, e.g., optical communications, linear optical classical and quantum computing, neuromorphic computing, and optical sensing.

In some embodiments, the exemplary VMM is configured as a compact, low loss, and fast optical switch with ultralow power consumption. The small size and the ultralow power consumption can allow for the implementation of large and dense optical network switches that enable a large number of optical systems, such as lidars and vector-matrix multipliers, with applications in, e.g., linear optical classical and quantum computing, neuromorphic computing, and AI accelerators.

In an aspect, an optical vector-matrix multiplier (VMM) is disclosed comprising a base layer; a two-dimensional (2D) electrode array arranged on top of the base layer; a waveguide layer arranged on top of the 2D electrode array, wherein the waveguide layer comprises a plurality of input waveguides and a plurality of output waveguides; and a liquid crystal layer evanescently coupled to the waveguide layer, wherein the liquid crystal layer has a spatially varying refractive index that is selectively defined by an electrical field generated by each electrode of the 2D electrode array, and wherein light is directed through the waveguide layer based on the spatially varying refractive index of the liquid crystal layer.

In some embodiments, the base layer comprises a CMOS chip or an interposer.

In some embodiments, the VMM further includes a top layer formed of glass or SU-8.

In some embodiments, the waveguide layer is separated from the base layer by a spacer.

In some embodiments, the spacer comprises a layer of photoresist.

In some embodiments, the layer of photoresist surrounds a top face and side edges of each electrode of the 2D electrode array such that each electrode of the 2D electrode array extends into the layer of photoresist.

In some embodiments, the layer of photoresist is SU-8.

In some embodiments, the liquid crystal layer is a nematic liquid crystal layer.

In some embodiments, the liquid crystal layer comprises an E7 mixture.

In some embodiments, the liquid crystal layer has a birefringence of nₑ−nₒ=0.22 at a wavelength of 1550 nm.

In some embodiments, the liquid crystal layer is formed by patterning a layer of photoresist.

In some embodiments, the waveguide layer is formed of amorphous silicon (aSi).

In another aspect, an optical waveguide switch is disclosed comprising a base layer; a two-dimensional (2D) electrode array arranged on top of the base layer; a liquid crystal layer; and one or more waveguides that extend through the liquid crystal layer, wherein the liquid crystal layer has a spatially varying refractive index that is selectively defined by an electrical field generated by each electrode of the 2D electrode array, and wherein light traveling through the one or more waveguides is manipulated based on the spatially varying refractive index of the liquid crystal layer by controlling the electrical field generated by each electrode of the 2D electrode array.

In some embodiments, the base layer comprises a CMOS chip or an interposer.

In some embodiments, the optical waveguide switch further includes a top layer formed of glass or SU-8.

In some embodiments, the liquid crystal layer is a nematic liquid crystal layer.

In some embodiments, the liquid crystal layer comprises an E7 mixture.

In some embodiments, the liquid crystal layer is formed by patterning a well into a layer of photoresist and filling the well with an E7 mixture.

In some embodiments, the one or more waveguides comprises at least three waveguides.

In some embodiments, the one or more waveguides are formed of amorphous silicon (aSi).

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

FIGS. 1A-1C are diagrams of an on-chip optical vector-matrix multiplier (VMM) that includes a linear PIC, according to some implementations.

FIGS. 2A-2C are diagrams of the VMM of FIG. 1, according to some implementations.

FIGS. 3A and 3B are diagrams of the refractive index of a liquid crystal (LC) of an example PIC waveguide and simulated light intensity through the same, according to some implementations.

FIGS. 4A and 4B are diagrams of the refractive index of an LC of an example PIC waveguide and simulated light intensity through the same, according to some implementations.

FIGS. 5A-5E include diagrams of an example configuration of a VMM with an integrated PIC, according to some implementations.

FIGS. 6A and 6B show example optical VMM arrays having a plurality of VMMs, according to some implementations.

FIGS. 7A-7D include diagrams of an example optical waveguide switch, according to some implementations.

FIGS. 8A-8D includes diagrams of an example configuration of a VMM with an integrated PIC for use in the optical waveguide switch of FIG. 7, according to some implementations.

FIGS. 9A-9C are diagram of an example bi-directional optical waveguide switch, according to some implementations.

FIG. 10A-10F show an LC-cladded strip waveguide evaluated in the study.

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

### DETAILED DESCRIPTION

Some references, which may include various patents, patent applications, and publications, are cited in a reference list and discussed in the disclosure provided herein. The citation and/or discussion of such references is provided merely to clarify the description of the present disclosure and is not an admission that any such reference is “prior art” to any aspects of the present disclosure described herein. In terms of notation, “[n]” corresponds to the n-th reference in the list. All references cited and discussed in this specification are incorporated herein by reference in their entirety and to the same extent as if each reference was individually incorporated by reference.

Referring generally to the figures, a reconfigurable optical vector-matrix multiplier (VMM) and related optical waveguide switch, as noted above, are shown, according to various implementations. The VMM described herein, in some implementations, can enable linear photonic integrated circuits (PICs), which can be rapidly (e.g., in approximately 10 μs) reconfigured. In some implementations, the VMM described herein enables linear PICs that can be derived using well-established CMOS electronic drivers developed and optimized for liquid crystal displays (LCDs). In some implementations, PICs enabled by the disclosed VMM are relatively simple to manufacture compared to conventional counterparts and low in cost. Devices based on the disclosed VMM can be programmed and reprogrammed in real-time to realize different PICs for applications in, e.g., optical communications, linear optical classical and quantum computing, neuromorphic computing, and optical sensing.

Existing photonic integration platforms, such as InP PICs [2] and silicon photonics [3], have successfully implemented photonic circuits with fixed functionalities for optical communications, sensing, and computation [7] applications. Such PICs are similar to application-specific integrated circuits (ASICs) used in electronics because their functionalities are fixed by lithographic patterning during fabrication. In addition, their response is sensitive to small imperfections and errors in the shape and dimensions of the patterned structures and their reliable fabrication requires precise control over nanoscale features. Several recent efforts have been dedicated to addressing these issues by developing tunable and partially reconfigurable PICs (e.g., [1], [9], [10], [11]). A goal of such efforts is to develop PICs that resemble electronic field-programmable gate arrays (FPGAs). The tunability alleviates the sensitivity to fabrication imperfections and the reconfigurability reduces the design cycle and cost of developing PICs. State-of-the-art reconfigurable PICs are composed of cascades or meshes of 2×2 couplers tuned by heaters and using the thermo-optic effect [1], [10], thus consuming significant power while providing limited reconfigurability and requiring complex calibration and programming algorithms.

The disclosed device addresses these issues and enables fully reconfigurable PICs with low power consumption. In contrast to other optical integration platforms, the flow of light in the chip's plane is entirely controlled by an array of electrodes that define a reconfigurable spatially varying refractive index distribution. The fabrication process of the proposed PICs does not involve lithography and patterning of the optical slab region; thus, nanoscale imperfections due to patterning do not affect the device performance. In some implementations, the functionality of the VMM described herein can be fully defined, e.g., through software. As mentioned above, most existing PICs are designed to have predefined fixed functions that are set by micro and nanoscale patterning of dielectrics, semiconductors, and metals. As a result, the development of any new photonic chip requires a significant investment and is time-consuming. Furthermore, a PIC that can be programmed and reconfigured quickly will enable highly desirable devices and systems such as lidar transceivers, large switches for optical communications, high-speed free-space optical communications, and accelerators.

The VMM described herein generally utilizes liquid crystals for reconfigurability. Liquid crystals are a proven technology for displays and liquid-crystal-on-silicon spatial light modulators. However, it has been long believed that they have significant absorption and scattering losses that limit their application in PICs and have a slow response. These and other limitations have been addressed by the VMM described herein through a design that alleviates loss-inducing mechanisms. As demonstrated herein, a high-speed response can be achieved using liquid crystals by driving them into their desired states using large electric fields. These advancements can enable a new class of PICs that are fully reconfigured in sub-millisecond time scales and with a power consumption at least 6 orders of magnitude lower than competing solutions.

As noted above, also disclosed herein, is a compact, low-loss, and fast optical switch with ultralow power consumption. The small size and the ultralow power consumption allow for the implementation of large and dense optical network switches that enable a large number of optical systems, such as lidars and vector-matrix multipliers, with applications in, e.g., linear optical classical [7] and quantum computing [13], neuromorphic computing [14], and AI accelerators [14]. The exemplary system and method can be employed in such architectures.

The disclosed optical switch consumes orders of magnitudes lower power than competing technologies (e.g., thermo-optic and carrier-injection) and is significantly smaller than waveguide switches with low power consumption (e.g., electro-optic, depletion, and MEMs). The switching mechanism, which is based on phase matching, is different from other switches that are typically based on interference (e.g., Mach-Zehnder interferometer or changing the coupling strength, MEMs switches with moving waveguides). Example VMM with Linear PIC

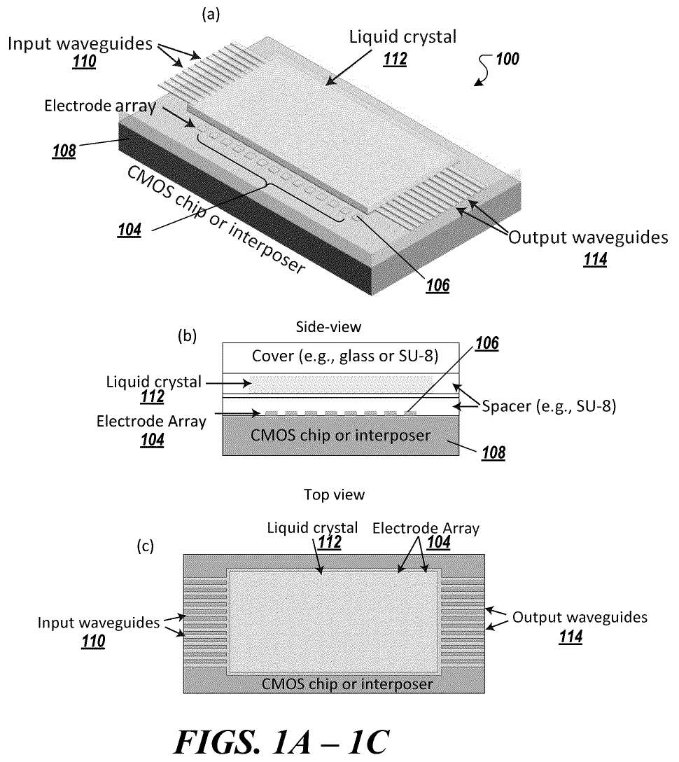

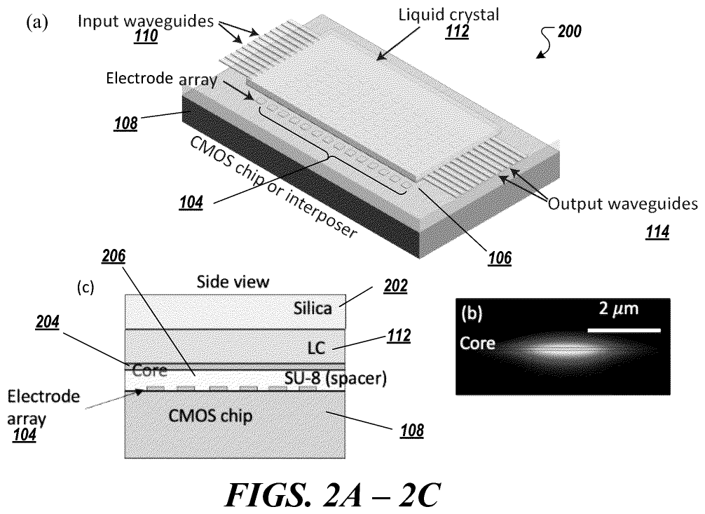

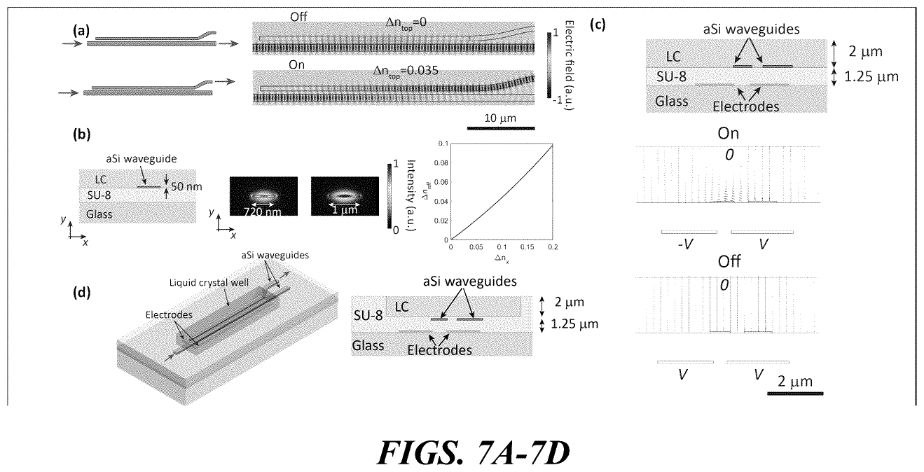

Referring now to FIG. 1, diagrams of an on-chip optical vector matrix multiplier (VMM) 100 that includes a linear photonic integrated circuit (PIC) 102 are shown, according to some implementations. FIGS. 2 and 7 each show alternative embodiments of the VMM 100 (shown as 200, 700).

In the example shown in FIGS. 1, 2, and 7, the VMM (e.g., 100, 200, 700) includes a 2-dimensional (2D) array 104 of electrodes 106 on a CMOS chip or an interposer (108), a set of input waveguides 110, an optical slab waveguide evanescently coupled to or formed on a layer of nematic liquid crystal (LC) 112 (shown as “Liquid Crystal” 112), and a set of output waveguides 114. An interposer is an electrical interface routing between a socket or a connection to another.

The VMM 100 is an example implementation of the universal linear optical element and can be entirely reconfigured using a dense array 104 of electrodes 106, e.g., fabricated on silicon chips 108. The device 100 can also implement a wide range of waveguide-based PICS and enables a new family of integrated optics components and structures based on on-demand continuously varying refractive index distributions.

In some implementations, light is input from a set of input waveguides 110 and then enters a slab waveguide region that is evanescently coupled to a layer of LC 112 with a spatially varying refractive index, which is defined by the voltages of the electrode array 104. The light is confined to the slab waveguide (e.g., of the LC 112) and is diffracted and directed by the spatially varying refractive index of the LC as it propagates in or along a plane of the chip. The LC's director direction, and thus the local effective index of the slab waveguide, is controlled by a quasi-electrostatic field generated by an electrode array 104 that is energized and controlled by a CMOS silicon chip 108. The dense array 104 of electrodes 106 allows for the realization of a wide range of refractive index distributions. By selecting the electrode voltages, waveguides and structures with continuously varying refractive index distributions can be realized. The VMM (e.g., 100) enables low-cost lithography-free fully reconfigurable linear PICs whose programming and control complexities are delegated to well-established CMOS chips.

Referring now to FIGS. 2A-2C, schematic diagrams of an implementation of the VMM 100 (now shown as 200) of FIG. 1 and method of operation are shown, according to some implementations. As shown in FIG. 2C, a few micron thick layer of a nematic LC 112 is sandwiched between an optical chip 202 and an electronic chip 108. The optical chip 202 is a slab waveguide composed of a high refractive index core layer such as silicon, as a low refractive index cladding (e.g., SiO₂) and is evanescently coupled to or formed on a nematic LC layer 112. The nematic LC 112 is composed of elongated molecules that are aligned approximately parallel to each other, though not necessarily arranged in a well-defined plane. The average direction along their length may be described by a unit vector n as the director and is spatially varied across the LC volume. Nematic LC 112 can behave like uniaxial crystals and exhibit an extraordinary refractive index of nₑ for light polarized along the director and an ordinary refractive index of nₒ for light polarized normal to the director direction. The LC molecules' orientation and, thus the director's orientation can be controlled by applying a quasi-static (with kHz frequency range) electric field. The zero-field orientation of the molecules and the director's distribution in a thin layer of LC 112 is typically defined by the condition at the LC layer boundaries and using intentionally defined alignment layers.

In some embodiments, the frequency range is from 1 kHz-200 kHz, e.g., 1 kHz-2 kHz, 2 kHz-3 kHz, 3 kHz-4 kHz, 4 kHz-5 kHz, 5 kHz-6 kHz, 6 kHz-7 kHz, 8 kHz-9 kHz, 9 kHz-10 kHz. In some embodiments, the frequency range is from 1 kHz-10 kHz, 10 kHz-20 kHz, 20 kHz-30 kHz, 30 kHz-40 kHz, 40 kHz-50 kHz, 50 kHz-60 kHz, 60 kHz-70 kHz, 70 kHz-80 kHz, 80 kHz-90 kHz, 90 kHz-100 kHz, 100 kHz-110 kHz, 110 kHz-120 kHz, 120 kHz-130 kHz, 130 kHz-140 kHz, 140 kHz-150 kHz, 150 kHz-160 kHz, 160 kHz-170 kHz, 170 kHz-180 kHz, 180 kHz-190 kHz, 190 kHz-200 kHz. In some embodiments, the frequency is greater than 200 kHz.

The VMM (100) may use an LC layer 112 whose director axis at zero fields is aligned normal to the chip's plane. Such an alignment is known as the homeotropic alignment, to provide a transverse electric (TE) mode of the slab waveguide, whose electric field is polarized parallel to the chip's plane, is not affected by the anisotropy of the LC 112 at zero applied field. Applying a quasi-static electric field along a direction parallel to the plane of the chip can rotate the director axis, increasing the in-plane refractive index of the LC cladding and thus affecting the propagation of the TE-polarized light inside the slab. In its simplest form, the director's orientation over a straight strip of the LC layer 112 can rotate and become parallel to the chip's plane and normal to the strip's direction. Such a distribution can be generated using two parallel electrodes and can lead to the confinement of light in the slab's plane by defining a straight waveguide. FIG. 2B shows numerical simulation results of the intensity distribution of a waveguide mode defined this way and demonstrates that small mode sizes are possible in the platform. The slab core 204 is assumed to be a 70 nm-thick amorphous silicon (aSi) layer, and the LC is an E7 mixture with a birefringence of nₑ−nₒ=0.22 at the wavelength of 1550 nm [16], [17].

### Example Methods of Operations

The 2D electrode array 104, e.g., shown in FIGS. 1A-IC and 2A-2C, among others herein, can generate a spatially varying electrostatic field and director and refractive index distribution; thus, it can be used to control the flow of light in the chip's plane.

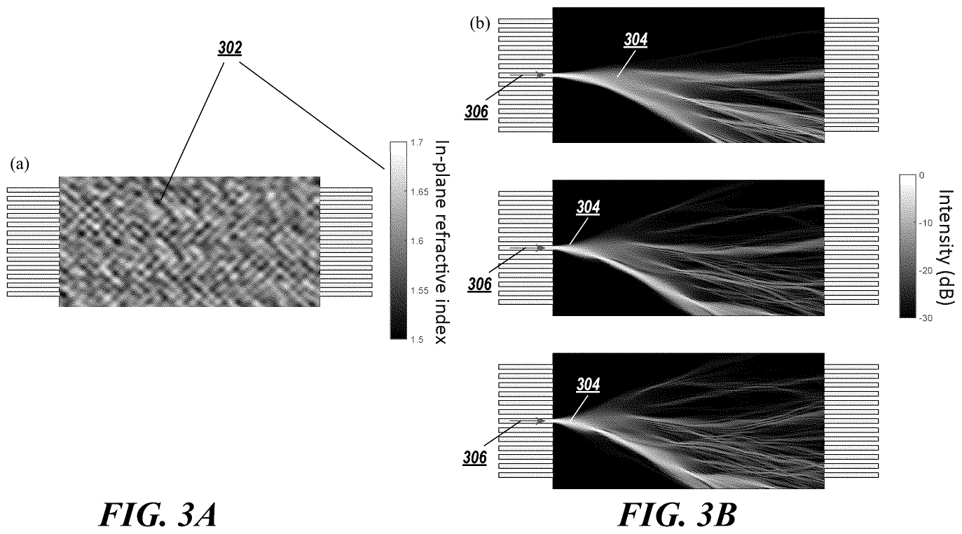

FIGS. 3A and 3B are diagrams of the refractive index of a liquid crystal (LC) of an example PIC waveguide and simulated light intensity through the same to demonstrate an example method of operation, according to some implementations. Specifically, FIG. 3A shows the in-plane refractive index 302 of the LC that is generated using the voltages applied to the 2D electrode array. FIG. 3B shows the light distribution 304 as it enters from one of the waveguides (marked by an arrow 306) and propagates through the slab waveguide while it is diffracted by the LC. The light intensity distributions 304 for three different electrode voltages are shown in the figure and shows that the intensity received in the output waveguide can be controlled by the electrode voltages.

For N input waveguides and M output waveguides for a VMM device that can receive complex-valued phasor amplitude of the optical waves in the input and output waveguides by N×1 and M×1 vectors a and b, respectively, the operation performed by the VMM shown in FIG. 3A can be expressed as b=La where L is an M×N matrix. M can be between 1 and 10000, and N can be between 1 and 10000. The input can be about 8, 16, 32, 64, 128, 192, 256, 320, 384, 448, 512, 576, 640, 704, 768, 832, 896, 960, 1024, etc. The output can be about 8, 16, 32, 64, 128, 192, 256, 320, 384, 448, 512, 576, 640, 704, 768, 832, 896, 960, 1024, etc. Other numbers of inputs nad outputs can be employed. When the i^{th} input waveguide is excited by an optical wave with amplitude “1,” the amplitudes of the waves in the output waveguide represent the i^{th} row of matrix L. As FIG. 3A shows, the matrix is defined and can be modified by applying different voltages to the electrodes using the CMOS chip.

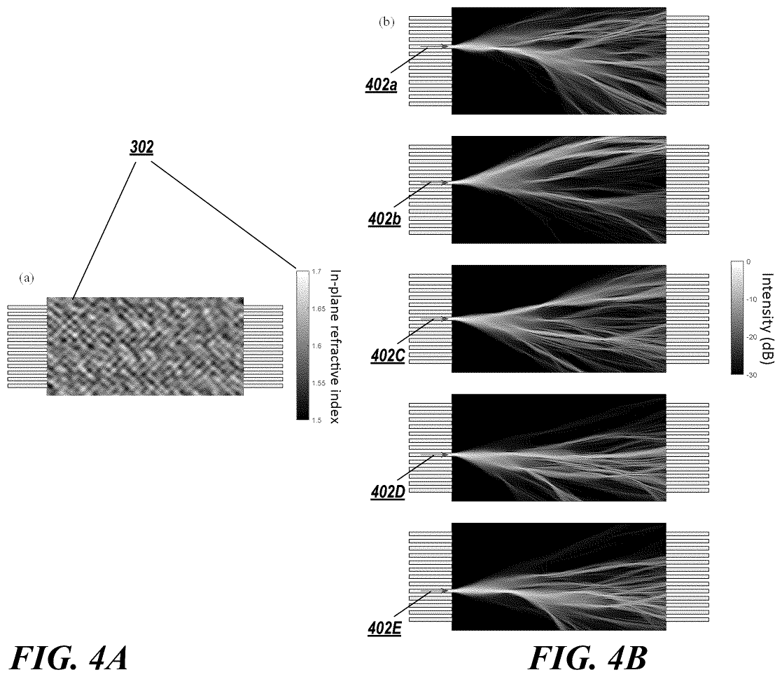

For a given LC index distribution (i.e., fixed electrode voltages), light entering from different input waveguides is directed to output waveguides by different ratios and phase shifts that are given by the elements in different rows of the L matrix. FIG. 4A shows an example of the index distribution 302, and FIG. 4B shows that light entering from different input waveguides 402a, 402b, 402c, 402d, 402e, shown by arrows in the figure, is directed by different ratios to different output waveguides.

In the example of a vector matrix multiplier, the input can be applied to a given pattern of electrode array having a matrix p×q to perform a multiplier operation that can be observed at the output. The multiplier can thus be used as a processing unit or co-processing unit that operates with a microprocessor.

In the example of a switch, the input can be applied to a given pattern of electrodes, e.g., corresponding to network addresses, to allow for routing.

### Example Electrodes and Fabricated Devices

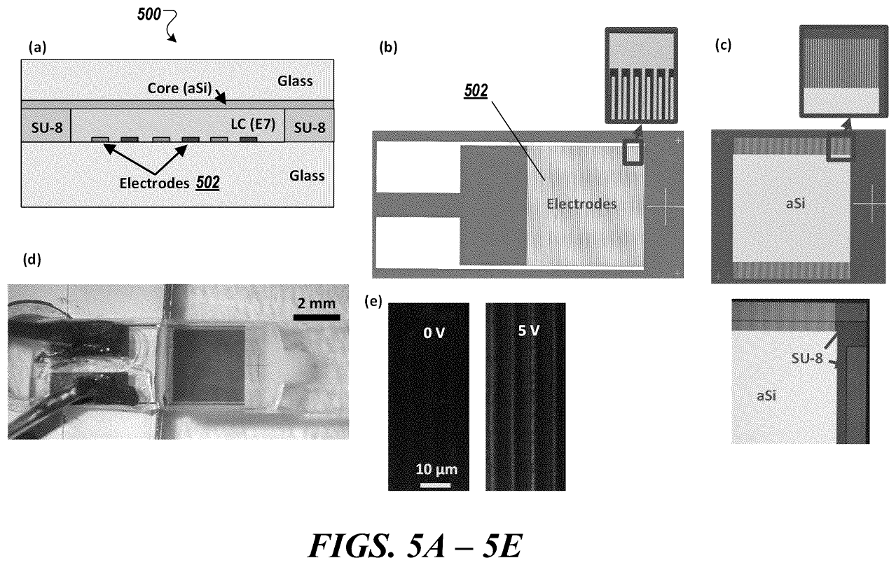

Referring now to FIGS. 5A-5E, diagrams of an example configuration of a VMM (e.g., 100) are shown, according to some implementations. In particular, FIG. 5A shows a cross-section of the VMM 100 (shown as 500), FIGS. 5B and 5C shows an optical microscope photos of the electronic and optical chips, respectively, FIG. 5D shows a photo of a prototype VMM, and FIG. 5E shows optical microscope photos of the center region of the device, showing the transmitted light when the device is placed between two crossed polarizers and at 45° with respect to the polarizers' axes. It can also be seen that FIGS. 5B and 5C include expanded views of certain areas of the optical microscope photos. As shown, patterned SU-8 spacers may be included.

In this example, the VMM 500 includes an array 104 of interdigitated electrodes 106 (now referred to as 502) that can generate and define uniform electric fields along the electrode's length. In some implementations, the electronic chip's surface is planarized by spin coating a ˜200-nm-thick layer of SU-8 polymer (e.g., 206; FIG. 2C) so that the non-uniform surface morphology of the electrodes does not affect the LC's director distribution. In some implementations, the optical chip is fabricated by depositing a silicon (Si) (e.g., 50-nm-thick layer of silicon) on a fused silica substrate and patterning the slab region and a set of short waveguides for feeding light from the edge of the sample to the slab region. In some implementations, a patterned SU-8 polymer (e.g., 7-μm-thick layer of SU-8 layer) is used to define the LC cell and can serve as the spacer between the two cells. The silicon can be about 10 nm thick, 20 nm thick, 30 nm thick, 40 nm thick, 50 nm thick, 60 nm thick, 70 nm thick, 80 nm thick, 90 nm thick, 100 nm thick. In some embodiments, the silicon layer is over 100 nm thick. The polymer layer can be thinner than the silicon layer, e.g., 2 μm, 3 μm, 4 μm, 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, 20 μm. In some embodiments, the polymer layer is greater than 20 μm thick.

In some implementations, the surface of each chip is coated with monolayers of a hexadecyltrimethylammonium bromide surfactant (HTAB) for achieving the homeotropic alignment of the LC [15]. Other surfactants can be used.

Finally, in some implementations, each chip was diced and bonded, and the LC cell filled with the E7 liquid crystal mixture (e.g., FIG. 5A), e.g., 4-cyano-4′-n-pentyl-biphenly (5CB), 4-cyano-4′-n-heptyl-biphenyl (7CB), 4-cyano-4′-n-oxyoctyl-biphenyl (80CB), 4-cyano-4″-n-pentyl-terphenyl (5CT), or a combination thereof.

To confirm the homeotropic alignment and that the interdigitated electrodes define stripes of the director's reorientation, the transmission of visible light normal to the bonded chip's plane was measured. The bonded chip was placed between two crossed polarizers, and the electrodes were at 45° with respect to the polarizer's transmission axes. The transmitted light was imaged using an optical microscope, and the recorded photos are presented in FIG. 5E. As shown, the LC in the cell does not change light's polarization when 0V is applied between the electrodes, thus confirming the homeotropic alignment of the LC. Also, applying a 60 kHz square wave with 5V peak-to-peak amplitude creates the expected stripes that define the waveguides. It should be understood that an AC voltage should be applied to prevent voltage screening by the charged ions present in the LC.

Next, it was confirmed that the transmitted light—and thus the director's orientation—are not modulated at the 1 kHz rate of the applied voltage; therefore, the waveguides defined by the LC are not temporally modulated. To further examine the creation and propagation loss of waveguides defined by the LC, a 1550 nm laser light was coupled to one of the short aSi waveguides at the edge of the device. The coupling was achieved by focusing the polarized laser light on the waveguide's diced facet using a microscope objective and imaging the chip from the top using another microscope objective, a tube lens, and an InGaAs camera. By applying a square wave with 5 Vₚ₋ₚ to the electrodes, an array of waveguides were formed and the light entering the slab from the short aSi waveguide was guided by one of them that was best aligned to the aSi waveguide.

In some implementations, the waveguides could be “switched off” using the electrode voltage, to examine the propagation loss by observing the light's intensity scattered off from the LC-defined waveguide. It was found that the propagation loss is on the order of a few dB/cm. Scattering loss dominates the propagation loss in LCs due to the director's thermal fluctuations; however, the light in the slab only interacts with the LC close to the slab's surface whose director's orientation is anchored at the surface by the alignment layer (the surfactant monolayer). This finding is consistent with previous reports of a significant reduction of propagation loss in anchored LCs.

### Optical VMM Array

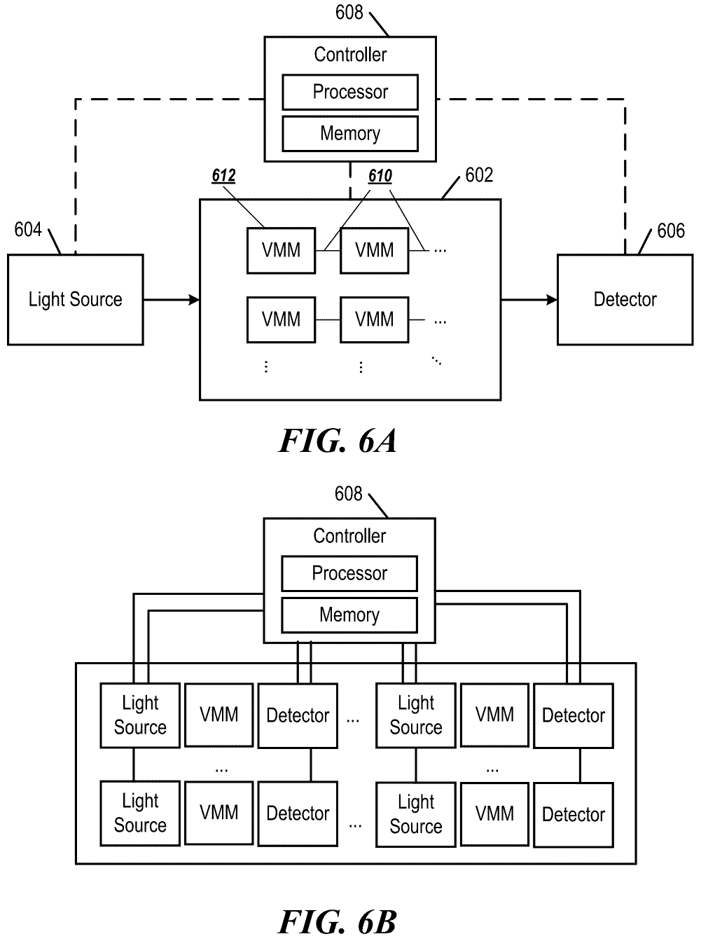

FIGS. 6A and 6B show example optical VMM arrays having a plurality of VMMs. In FIG. 6A, the system includes an array 602 of optical VMMs (e.g., 100, 200, 500) in which the VMM operates with each other and to a light source and detector. In FIG. 6B, the system includes an array of VMMs in which each is configured with a light source and detector.

In FIGS. 6A and 6B, array 602 can include any number of optical VMMs (e.g., n VMMs), e.g., arranged into a grid pattern or another type of 2-dimensional (2D) pattern, e.g., a×b, where a=1, . . . 10000 and b=1×10000, e.g., 1×1, 1×2, 1×3, . . . 1×n, 2×1, 2×2, 2×3, 2×n, 3×1, 3×2, 3×3, . . . , 3×n, 4×1, 4×2, 4×3, . . . , 4×n, 5×1, 5×2, 5×3, . . . , 5×n, where n can be 3 to 10000. In some embodiments, the optical VMMs are arranged in 10×n, 20×n, 30×n, 40×n, 50×n, 60×n, . . . n×n, where n can be from 1 to 10000. Other array size of VMMs and configurations can be applied.

Generally, in FIG. 6A, the output 610 of each optical VMM 612 is coupled to an input of one or more neighboring VMMs such that light is passed between VMMs; however, at least two rows or columns of array 602. Typically, the outermost rows/columns of array 602—may be coupled to a light source 604 and a detector 606. In the example shown, the leftmost and rightmost columns are coupled to light source 604 and detector 606, respectively. Light source 604 is generally configured to generate and emit light into array 602, where it is manipulated by the individual VMMs of array 602. Likewise, detector 606 is generally configured to detect the light after it has passed through array 602. As described herein, light source 604 and detector 606 may be any suitable light source and detector, respectively. For example, light source 604 may be a laser or an array of lasers and detector 606 may be configured to detect light in the wavelength output by light source 604.

As shown, a controller 608 can further be electrically coupled to one or more of array 602, light source 604, and detector 606 to control the operations of each component. In particular, controller 608 may be configured to control light source 604 by selectively activating 604, e.g., to cause light source 604 to emit light. In some implementations, controller 608 can transmit data to light source 604 to cause light source 604 to emit light in specific patterns, etc. In some implementations, controller 608 can receive and process data from detector 606. For example, controller 608 can extract data based on the light detected by detector 606. In some implementations, controller 608 can control each optical VMM of array 602 by controlling a voltage provided to the electrode array on each optical VMM. In this regard, controller 608 may be able to dynamically reconfigure each optical VMM to modify the transmission of light through array 602. Thus, array 602 can be operated as an optical field programmable gate array (FPGA).

Controller 608 is shown to include a processor and memory. The processor can be a general-purpose processor, an ASIC, one or more FPGAs, a group of processing components, or other suitable electronic processing structures. In some embodiments, the processor is configured to execute program code stored on memory to cause controller 608 to perform one or more operations, as described below in greater detail. It will be appreciated that, in embodiments where controller 608 is part of another computing device, the components of controller 608 may be shared with, or the same as, the host device.

Memory can include one or more devices (e.g., memory units, memory devices, storage devices, etc.) for storing data and/or computer code for completing and/or facilitating the various processes described in the present disclosure. In some embodiments, the memory includes tangible (e.g., non-transitory), computer-readable media that store code or instructions executable by the processor. Tangible, computer-readable media refers to any physical media that is capable of providing data that causes controller 608 to operate in a particular fashion. Example tangible, computer-readable media may include, but is not limited to, volatile media, non-volatile media, removable media and non-removable media implemented in any method or technology for storage of information such as computer-readable instructions, data structures, program modules or other data. Accordingly, memory can include RAM, ROM, hard drive storage, temporary storage, non-volatile memory, flash memory, optical memory, or any other suitable memory for storing software objects and/or computer instructions. Memory can include database components, object code components, script components, or any other type of information structure for supporting the various activities and information structures described in the present disclosure.

While shown as individual components, it will be appreciated that the processor and/or memory can be implemented using a variety of different types and quantities of processors and memory. For example, the processor may represent a single processing device or multiple processing devices. Similarly, memory may represent a single memory device or multiple memory devices. Additionally, in some embodiments, controller 608 may be implemented within a single computing device (e.g., one server, one housing, etc.). In other embodiments, controller 608 may be distributed across multiple servers or computers (e.g., that can exist in distributed locations). For example, controller 608 may include multiple distributed computing devices (e.g., multiple processors and/or memory devices) in communication with each other that collaborate to perform operations. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In some implementations, rather than communicating directly with controller 608, one or more of array 602, light source 604, and detector 606 may alternatively or additionally coupled to another remote computing device.

### Optical Waveguide Switches

FIGS. 7A-7D, 8A-8D, and 9A-9C show an example compact and ultralow power liquid crystal switch, according to some implementations. In some implementations, the optical waveguide switch enables a general reconfigurable linear optical system that can be programmed in real-time to realize different operations for applications in, e.g., optical communications, linear optical classical and quantum computing, neuromorphic computing, AI accelerators, and optical sensing.

The number of electrical connections for the ultralow power liquid crystal switch may be smaller as compared to the structure, e.g., for a vector matrix multiplier. In some embodiments, the number of electrical connections may be between two and four to either drive an external driver or use an integrated CMOS driver.

An array of switches can be used to make an optical circuit with some reconfigurability. A single switch can also operate as an independent device without having to be implemented in an array. The ultralow-power liquid crystal switch may be employed in similar application domains (AI accelerators, Linear quantum optics commuting, Optical communications, Lidars, etc., e.g., as described in relation to [22], [23], [24]) The switch may have a smaller footprint for applications that have a few inputs and a few outputs but the VMM (e.g., discussed above) can provide a more compact and versatile structure for the case when the number of inputs and outputs are larger than, for example, ten.

Referring first to FIGS. 7A-7D, in particular, a 1×2 version of the switch is shown. In particular, FIG. 7A illustrates a 1×2 waveguide switch composed of two coupled waveguides with different widths. The waveguide switch is generally configured to turn ON when the effective index of the narrower waveguide is increased by 0.035. Also shown in FIG. 7B are cross sections of the waveguides cladded on top by a liquid crystal, the mode intensity distributions for the two waveguides of the switch. The change in the effective index of the narrower waveguide as a function of the change in the refractive index of the liquid crystal is shown on the right of the cross-section. FIG. 7C further includes a cross-section of the switch and simulated quasi-electrostatic field distribution that turns ON the switch and drives it to its OFF state and a cross-section and a 3D illustration of the switch. FIG. 7D shows a cross-section and a 3D illustration of the switch.

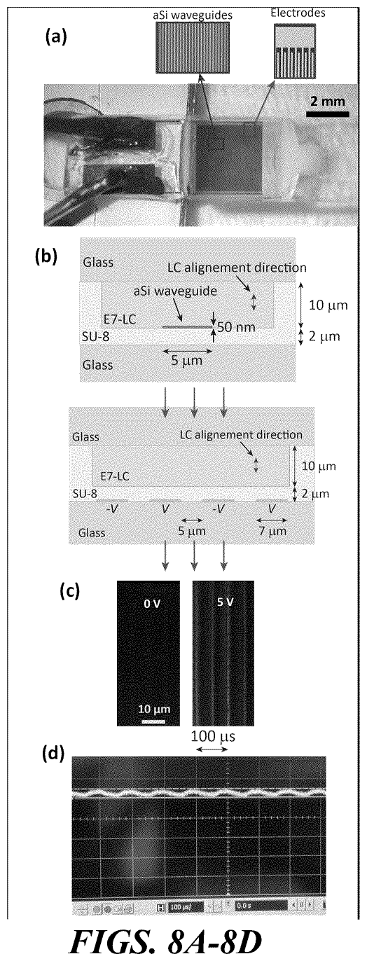

In general, the switch is composed of two evanescently coupled waveguides of different widths. Because of the different widths, the two waveguides have different effective indices (e.g., are not phase-matched) and the light does not efficiently couple from one to another. By properly selecting the coupling length of the two waveguides, the coupling between the two waveguides can become very small (e.g., the OFF state of the switch). Simulation results for two amorphous silicon (aSi) waveguides with a core thickness of 50 nm and widths of 0.72 μm and 1 μm are also shown in FIG. 8C. The switch has a very small loss of lower than 0.001 dB in its OFF state. If the effective index of the narrower waveguide (e.g., the top waveguide in FIG. 7C) is increased by Δ_{n_top}=0.035, the two waveguides are phase matched, and a significant portion of the power will be coupled to the top waveguide, and the switch will turn ON. The simulation results for this case are also shown in FIG. 7C, and the switch has a loss of 0.22 dB in its ON state.

The schematic of the cross-section and the optical intensities for the TE modes of the two waveguides composing the switch are shown in FIG. 7B. In these simulations, it is assumed that the lower cladding is SU-8 (e.g., a refractive index of 1.57 at 1.55 μm) and the top cladding is a 2-μm-thick layer of E7 nematic liquid crystal (e.g., nₒ=1.5 and nₑ=1.72 at 1.55 μm [25], [26]) that is aligned to have its director normal to the plane of the chip (e.g., homeotropic alignment) in its relaxed state. As a result, the cladding index for TE modes of the waveguides is nₒ. Applying a quasi-static electric field along a direction parallel to the plane of the chip and in the region over the narrower waveguide rotates the director axis of the LC and effectively increases the refractive index of the cladding by Δnₓ for the TE mode of the narrower waveguide. The simulated change in the effective index of the narrower waveguide as a function of Δnₓ is shown in FIG. 7B and shows that an effective index increase of up to 0.1 for the narrower waveguide is achievable using this approach.

A localized quasi-electrostatic field can be applied using two electrodes placed under the two waveguides, as shown. The gap between the two electrodes is aligned to the center of the narrower waveguide such that the static field is mainly along the x-axis in the region over the narrower waveguide and along the y-axis over the wider waveguide, as verified by the electrostatic simulation results. By applying a field with a correct amplitude, an effective index change of 0.035 is achievable, and the switch can be turned ON. The power consumption of the switch, when driven by a 200 kHz, 5 V peak-to-peak signal, is estimated as 5 nW using its approximate impedance value of 100-j700 MΩ [27]. FIG. 7D shows a schematic of the switch that shows the electrodes, the waveguides, and the LC well.

### Experimental Results and Additional Examples

A study was conducted to develop and evaluate an optical vector matrix multiplier (VMM) and related optical waveguide switch, e.g., for the exemplary device and method described in relation to FIGS. 1-7.

LC Loss and Speed. The study evaluated the LC loss and speed. FIG. 8A shows photo of the device with LC cladding. FIG. 8B shows waveguides with LC cladding and electrodes under the LC layer are fabricated on the device. FIG. 8C shows microscope images of the electrode area when placed between crossed polarizers when 0V and 5V peak to peak is applied between the electrodes. FIG. 8D shows modulation of the transmitted light at 10 kHz by driving the electrodes by 30V peak to peak.

Two potential concerns related to the use of LCs are their potential excess loss and switching speeds. To examine these issues, the device shown in FIG. 8A was fabricated. Two types of structures were included on the device for the study of the LC-induced loss and its switching speed (FIG. 8B): an aSi waveguide with LC cladding and an interdigitated array of electrodes separated from the LC by an SU-8 spacer layer. A 10-μm-deep well was patterned into SU-8 for the LC layer, and the sample was filled with the E7 LC. The propagation loss of the LC-cladded aSi waveguides was examined by coupling 1.55 μm laser and imaging the chip from the top. It was found that the waveguide loss is less than a few dB/cm. The finding is consistent with an LC-cladded slab waveguide that has an experimentally measured propagation loss of less than 0.5 dB/cm [28].

To determine the switching speed of the LC, the transmission of visible light normal to the chip's plane was measured (FIG. 8B bottom). In particular, the device was placed between two crossed polarizers, and the transmitted light was measured and imaged when applying no voltage or a 5V peak-to-peak, 200 kHz square wave between the electrodes. As shown in FIG. 8C, the LC is switched at 5V, e.g., determined by modulating the amplitude of the 200 kHz signal by a lower frequency signal. The 3 dB bandwidth of the LC was found to be ˜100 Hz for a 5 V peak-to-peak voltage amplitude. However, the 3 dB bandwidth was increased to ˜10 kHz by increasing the voltage amplitude to 60 V peak-to-peak (FIG. 8D). Considering these preliminary results, the loss induced by the LC is not considered to be a limiting factor and the target switching speed of 100 us is achievable by increasing the applied voltage to ˜60 V peak to peak.

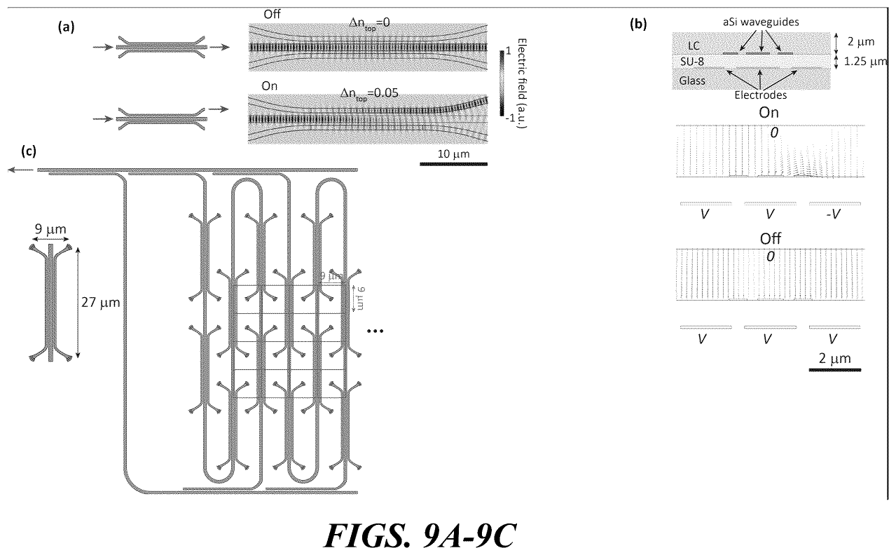

Bidirectional 1×3 waveguide switch. The study evaluated a 1×3 waveguide switch. FIG. 9A shows compact bidirectional 1×3 switch and its full wave simulations when the top waveguide's effective index is unchanged (OFF state) and increased by 0.05 (ON state). FIG. 9B shows a cross section of the switch and quasi-static field generated by the electrodes in the ON state and for driving the switch into its OFF state. FIG. 9C shows a layout of a dense switch network.

Referring now to FIG. 9, a compact bidirectional 1×3 switch is shown, according to some implementations. The switch of FIG. 9 generally operates based on the same principle as the switch shown in FIG. 7A, above, has a smaller footprint, and provides 4× its switching capacity (2× in each direction). In this switch, two similar narrow waveguides are coupled to a wider center waveguide, and light can be coupled to either of them by changing their effective refractive index by 0.05. The switch can also operate in the reverse direction (i.e., when the light inputs the center waveguide from the right). The simulation results in FIG. 9A indicates an OFF state insertion loss of less than 0.001 dB for the switch, a 0.41 dB loss in the ON state, and a crosstalk of −18 dB between the bottom and top waveguide. As FIG. 9C shows the change in the effective index of either of the narrow waveguides can be accomplished using three electrodes under the waveguides, and the switch can be driven to ON and OFF states (i.e., not relying on the relaxation of LC) and thus increasing the switching speed. In some implementations, a 2D switch network with a pitch of 9 μm can be realized using this switch. The direction of light entering the switches is controlled using two-row switches that are connected to each column.

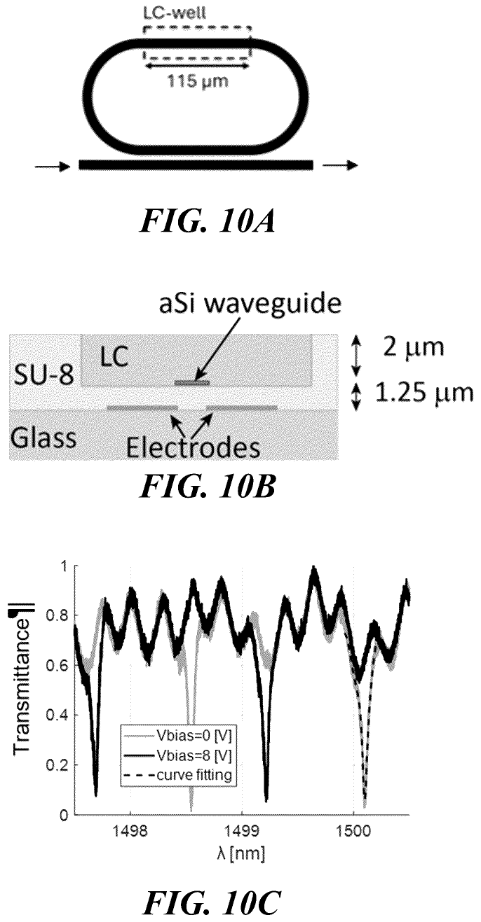

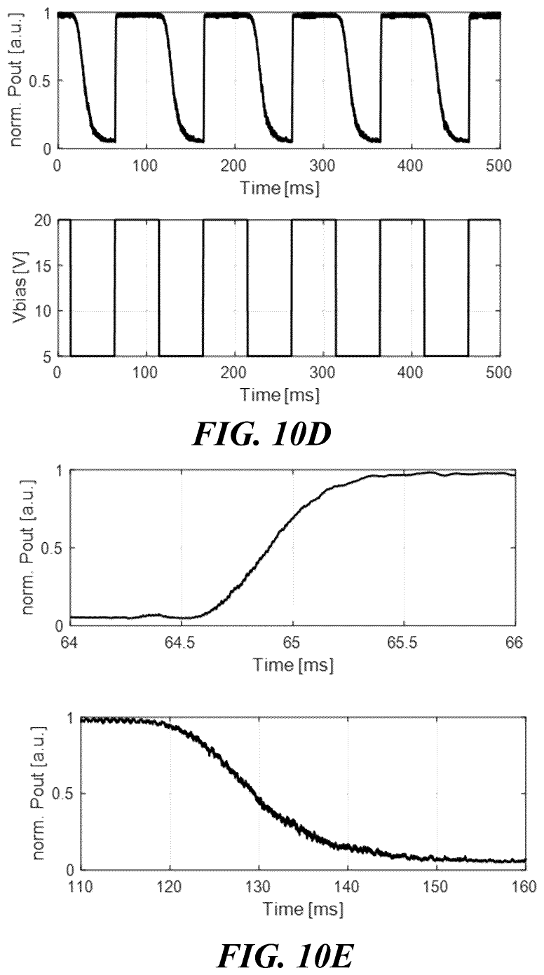

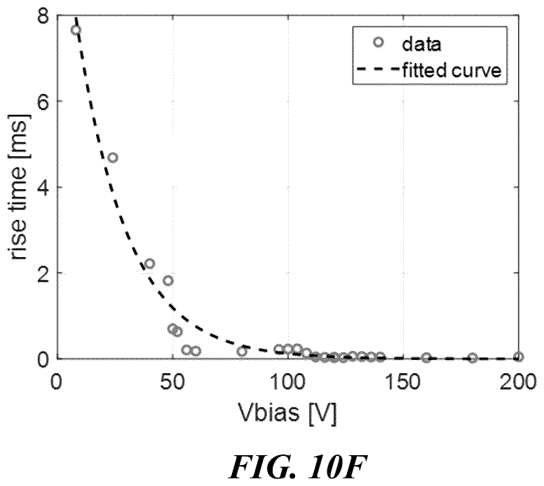

LC-cladded strip waveguide. FIG. 10A-10F show an LC-cladded strip waveguide evaluated in the study. FIG. 10A shows an LC-cladded strip waveguide in a race-track resonator. The resonator can be used for determining the waveguide propagation loss and the change in its effective index with applied bias voltage.

FIG. 10B shows a cross section of the waveguide.

FIG. 10C shows a measured transmittance of the resonator shown in FIG. 10A for different values od the applied voltage between the electrodes. The resonances have a quality factor of 3.7×104 corresponding to effective propagation loss of 1.58 dB/mm. The change of the resonant wavelength with voltage confirms the change of change of waveguide effective index without affecting the its loss.

FIG. 10D shows the measured transmitted power of the resonator shown in FIG. 10A as a function of time (top) when a time varying bias voltage is applied to the electrodes (bottom).

FIG. 10E shows an expanded views of the rising (top) and falling (bottom) edges of the transmitted optical power shown in FIG. 10D.

FIG. 10F shows the measured rise time of the switching response of the resonator shown in FIG. 1 as a function of applied voltage bias. The minimum observed rise time value is 24 μs.

### Configuration of Certain Implementations

The construction and arrangement of the systems and methods as shown in the various implementations are illustrative only. Although only a few implementations have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied, and the nature or number of discrete elements or positions may be altered or varied. Accordingly, all such modifications are intended to be included within the scope of the present disclosure. The order or sequence of any process or method steps may be varied or re-sequenced according to alternative implementations. Other substitutions, modifications, changes, and omissions may be made in the design, operating conditions, and arrangement of the implementations without departing from the scope of the present disclosure.

Although the figures show a specific order of method steps, the order of the steps may differ from what is depicted. Also, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps.

It is to be understood that the methods and systems are not limited to specific synthetic methods, specific components, or to particular compositions. It is also to be understood that the terminology used herein is for the purpose of describing particular implementations only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another implementation includes from the one particular value and/or to the other particular value. Similarly, when values are expressed as approximations, by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal implementation. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific implementation or combination of implementations of the disclosed methods.

The following patents, applications, and publications, as listed below and throughout this document, are hereby incorporated by reference in their entirety herein.

### REFERENCE LIST

[1] Harris, N. C. et al. Linear programmable nanophotonic processors. Optica 5, 1623 (2018).
[2] Smit, M., Williams, K. & Van Der Tol, J. Past, present, and future of InP-based photonic integration. APL Photonics 4, (2019).
[3] Chrostowski, L. & Hochberg, M. Silicon photonics design. Silicon Photonics Design (2015). doi: 10.1017/CBO9781316084168
[4] Liu, L. et al. An ultra-small, low-power, all-optical flip-flop memory on a silicon chip. Nat. Photonics 4, 182-187 (2010).
[5] Arafin, S. & Coldren, L. A. Advanced InP Photonic Integrated Circuits for Communication and Sensing. IEEE J. Sel. Top. Quantum Electron. 24, (2018).
[6] Tombez, L., Zhang, E. J., Orcutt, J. S., Kamlapurkar, S. & Green, W. M. J. Methane absorption spectroscopy on a silicon photonic chip. Optica 4, 1322 (2017).
[7] Shen, Y. et al. Deep learning with coherent nanophotonic circuits. Nat. Photonics (2017).
[8] Xing, Y. et al. Digitally controlled phase shifter using an SOI slot waveguide with liquid crystal infiltration. IEEE Photonics Technol. Lett. 27, 1269-1272 (2015).
[9] De Cort, W., Beeckman, J., Claes, T., Neyts, K. & Baets, R. Widely tunable silicon-oninsulator ring resonators with a liquid crystal cladding. IEEE Photonic Soc. 24th Annu. Meet. PHO 2011 3, 541-542 (2011).
[10] Bogaerts, W. et al. Programmable photonic circuits. Nature 586, 207-216 (2020).
[11] Chen, X. et al. The Emergence of Silicon Photonics as a Flexible Technology Platform. Proc. IEEE 106, 2101-2116 (2018).
[12] Zhang, W. & Yao, J. Photonic integrated field-programmable disk array signal processor. Nat. Commun. (2020). doi: 10.1038/s41467-019-14249-0
[13] Harris, N. C. et al. Quantum transport simulations in a programmable nanophotonic processor. Nat. Photonics (2017).
[14] Stark, P., Horst, F., Dangel, R., Weiss, J. & Offrein, B. J. Opportunities for integrated photonic neural networks. Nanophotonics (2020).
[15] Khoo, I. C. Liquid Crystals: Second Edition. Liquid Crystals: Second Edition (2006). doi: 10.1002/0470084030
[16] Li, J., Wu, S. T., Brugioni, S., Meucci, R. & Faetti, S. Infrared refractive indices of liquid crystals. J. Appl. Phys. 97, (2005).
[17] Brugioni, S. & Meucci, R. Refractive indices of the nematic mixture E7 at 1550 nm. Infrared Phys. Technol. 49, 210-212 (2007).
[18] Green, M. & Madden, S. J. Low loss nematic liquid crystal cored fiber waveguides. Appl. Opt. 28, 5202 (1989).
[19] Davis, S. R., Farca, G., Rommel, S. D., Martin, A. W. & Anderson, M. H. Analog, nonmechanical beam-steerer with 80 degree field of regard. Acquis. Tracking, Pointing, Laser Syst. Technol. XXII 6971, 69710G (2008).
[20] Chao, T.-H. et al. Compact liquid crystal waveguide based Fourier transform spectrometer for in-situ and remote gas and chemical sensing. Opt. Pattern Recognit. XIX 6977, 69770P (2008).
[21] Davis, S. R., Rommel, S. D., Farca, G. & Anderson, M. H. A new generation of previously unrealizable photonic devices as enabled by a unique electro-optic waveguide architecture. Liq. Cryst. XII 7050, 705005 (2008).
[22] Shen, Y. et al. Deep learning with coherent nanophotonic circuits. Nat. Photonics (2017).
[23] Harris, N. C. et al. Quantum transport simulations in a programmable nanophotonic processor. Nat. Photonics (2017).
[24] Stark, P., Horst, F., Dangel, R., Weiss, J. & Offrein, B. J. Opportunities for integrated photonic neural networks. Nanophotonics (2020).
[25] Li, J., Wu, S. T., Brugioni, S., Meucci, R. & Faetti, S. Infrared refractive indices of liquid crystals. J. Appl. Phys. 97, (2005).
[26] Brugioni, S. & Meucci, R. Refractive indices of the nematic mixture E7 at 1550 nm. Infrared Phys. Technol. 49, 210-212 (2007).
[27] Marzal, V. et al. Electrical Behavior of Liquid Crystal Devices with Dielectric Nanoparticles. J. Nanomater. 2020, (2020).
[28] Davis, S. R., Farca, G., Rommel, S. D., Johnson, S. & Anderson, M. H. Liquid crystal waveguides: new devices enabled by >1000 waves of optical phase control. Emerg. Liq. Cryst. Technol. V 7618, 76180E (2010).
[29] Green, M. & Madden, S. J. Low loss nematic liquid crystal cored fiber waveguides. Appl. Opt. 28, 5202 (1989).
[30] Davis, S. R., Farca, G., Rommel, S. D., Martin, A. W. & Anderson, M. H. Analog, nonmechanical beam-steerer with 80 degree field of regard. Acquis. Tracking, Pointing, Laser Syst. Technol. XXII 6971, 69710G (2008).
[31] Chao, T.-H. et al. Compact liquid crystal waveguide based Fourier transform spectrometer for in-situ and remote gas and chemical sensing. Opt. Pattern Recognit. XIX 6977, 69770P (2008).
[32] Davis, S. R., Rommel, S. D., Farca, G. & Anderson, M. H. A new generation of previously unrealizable photonic devices as enabled by a unique electro-optic waveguide architecture. Liq. Cryst. XII 7050, 705005 (2008).
[33] Geis, M. W. et al. 30 to 50 ns liquid-crystal optical switches. Opt. Express, Vol. 18, Issue 18, pp. 18886-18893 18, 18886-18893 (2010).
[34] Takanashi, H., Maclennan, J. E. & Clark, N. A. Sub 100 nanosecond pretilted planar-tohomeotropic reorientation of nematic liquid crystals under high electric field. Japanese J. Appl. Physics, Part 1 Regul. Pap. Short Notes Rev. Pap. 37, 2587-2589 (1998).

What is claimed is:

1. An optical vector matrix multiplier (VMM) comprising:
a base layer;
a two-dimensional (2D) electrode array arranged on top of the base layer;
a waveguide layer arranged on top of the 2D electrode array, wherein the waveguide layer comprises a plurality of input waveguides and a plurality of output waveguides; and
a liquid crystal layer evanescently coupled to the waveguide layer, wherein the liquid crystal layer has a spatially varying refractive index that is selectively defined by an electrical field generated by each electrode of the 2D electrode array, and wherein light is directed through the waveguide layer based on the spatially varying refractive index of the liquid crystal layer.

2. The VMM of claim 1, wherein the base layer comprises a CMOS chip or an interposer.

3. The VMM of claim 1, further comprising a top layer formed of glass or SU-8.

4. The VMM of claim 1, wherein the waveguide layer is separated from the base layer by a spacer.

5. The VMM of claim 4, wherein the spacer comprises a layer of photoresist.

6. The VMM of claim 5, wherein the layer of photoresist surrounds a top face and side edges of each electrode of the 2D electrode array such that each electrode of the 2D electrode array extends into the layer of photoresist.

7. The VMM of claim 5, wherein the layer of photoresist is SU-8.

8. The VMM of claim 1, wherein the liquid crystal layer is a nematic liquid crystal layer.

9. The VMM of claim 1, wherein the liquid crystal layer comprises an E7 mixture.

10. The VMM of claim 1, wherein the liquid crystal layer is formed by patterning a layer of photoresist.

11. The VMM of claim 1, wherein the waveguide layer is formed of amorphous silicon (aSi).

12. An optical waveguide switch comprising:
a base layer;
a plurality of electrodes arranged on top of the base layer;
a liquid crystal layer; and
one or more waveguides that extend through the liquid crystal layer, wherein the liquid crystal layer has a spatially varying refractive index that is selectively defined by an electrical field generated by each electrode of the plurality of electrodes, and wherein light traveling through the one or more waveguides is manipulated based on the spatially varying refractive index of the liquid crystal layer by controlling the electrical field generated by each electrode of the plurality of electrodes.

13. The optical waveguide switch of claim 12, wherein the base layer comprises a CMOS chip or an interposer.

14. The optical waveguide switch of claim 12, further comprising a top layer formed of glass or SU-8.

15. The optical waveguide switch of claim 12, wherein the liquid crystal layer is a nematic liquid crystal layer.

16. The optical waveguide switch of claim 12, wherein the liquid crystal layer comprises an E7 mixture.

17. The optical waveguide switch of claim 12, wherein the liquid crystal layer is formed by patterning a well into a layer of photoresist and filling the well with an E7 mixture.

18. The optical waveguide switch of claim 12, wherein the one or more waveguides comprises at least three waveguides.

19. The optical waveguide switch of claim 12, wherein the one or more waveguides are formed of amorphous silicon (aSi).

20. A switch comprising:
a waveguide comprising:
a base layer;
a plurality of electrodes arranged on top of the base layer;
a liquid crystal layer; and
one or more waveguides that extend through the liquid crystal layer, wherein the liquid crystal layer has a spatially varying refractive index that is selectively defined by an electrical field generated by each electrode of the plurality of electrodes, and wherein light traveling through the one or more waveguides is manipulated based on the spatially varying refractive index of the liquid crystal layer by controlling the electrical field generated by each electrode of the plurality of electrodes.
